(19) United States
(12) Patent Application Publication
(10) Pub. No.: US 2013/0045736 A1
(43) Pub. Date: Feb. 21, 2013

(54) SYSTEM, METHOD AND PRODUCT FOR VERIFYING THE ALLOCATION OF LOCALLY UNUSED RADIO FREQUENCIES

(71) Applicants: Louis H. LIBIN, Woodmere, NJ (US); Aldo CUGNINI, Long Valley, NJ (US)

(72) Inventors: Louis H. LIBIN, Woodmere, NJ (US); Aldo CUGNINI, Long Valley, NJ (US)

(21) Appl. No.: 13/587,981

(22) Filed: Aug. 17, 2012

Related U.S. Application Data
(60) Provisional application No. 61/575,195, filed on Aug. 17, 2011.
(60) Provisional application No. 61/573,445, filed on Sep. 6, 2011.

(51) Int. Cl. H04W 72/04; H04W 4/00

(52) U.S. Cl. 455/426.1

(57) ABSTRACT

Unlicensed wireless devices provide public and private capabilities that include the transfer of video, audio, other content, and additional information. This invention will allow users of these devices to be assured of reliable and authorized operation of said devices in the broadcast television spectrum at locations where that spectrum is unused by licensed services, as well as to provide for better utilization of the available communication channels

### RELATED APPLICATIONS

This application claims priority to U.S. Provisional Applications Ser. No. 61/575,195 filed on Aug. 17, 2011 and Ser. No. 61/573,445 filed on Sep. 6, 2011 incorporated herein by reference in their entirety.

### BACKGROUND OF THE INVENTION

A. Field of Invention

This application pertains to an apparatus and method for verifying what RF channels are available for use by unlicensed wireless devices in the TV band region in a given geographic locality.

B. Description of the Prior Art

Unlicensed wireless devices are now authorized for use in the United States broadcast television spectrum at locations where that spectrum is unused by licensed services. These locations are called the “TV bands,” and the unlicensed wireless devices are variously called “TV band devices” or “Television Band Devices (TVBDs)” or “White Space Devices.”

TVBDs usually radiate RF signals, and as such can interfere with other devices and/or other services. They must therefore operate under the strict Rules and Regulations of the Federal Communications Commission (the “FCC Rules”), and harsh penalties may be imposed on parties or device manufacturers operating or providing equipment that does not meet the FCC Rules.

All TVBDs must have the capability to access a database that identifies incumbent users entitled to interference protection, including, for example, full power and low power TV stations, broadcast auxiliary point-to-point facilities, PLMRS/CMRS operations on channels 14-20, and the Offshore Radiotelephone Service. Some TVBDs may additionally require a geo-location capability.

The rules for unlicensed devices that operate in the TV bands are set forth in Sections 15.701-0.717 of the FCC Rules (47 C.F.R. §§15.701-0.717). These rules also contain provisions for devices that rely on spectrum sensing to determine available channels, Licensed low power auxiliary devices (e.g. wireless microphones and other broadcast related devices) require registration prior to use, for each device, of the device's operator (responsible party), location, schedule, channels occupied, and license (call sign) information with a TVBD database administrator.

In accordance with the FCC Rules, if an operator wishes to register their licensed wireless channels, they can register the channels with one of the TVBD Database Administrators (DBA). The process is as follows:

1. The operator notifies the TVBD DBA of the frequencies to be used and the schedule for their use.

2. The TVBD Database Administrator notifies the Peer administrators of a new registration.

3. The TVBD Database Administrator receives notification that all the other database administrators have been notified.

4. The new registration is now added to the National TV Bands Database.

5. The new registration goes through a review process.

6. A new localized database is created.

7. TVBDs contact the DBA to establish that a channel is requested for use.

8. If there is no conflict, no signal is sent to the TVBD's but the National Database is modified.

9. If there is a conflict, a message is sent to the TVBD in that channel to relocate to a different channel.

10. The national database is modified/updated with schedules, user information and data and time.

### SUMMARY OF THE INVENTION

The invention is based on one or more of the following technologies: wireless RF (radio frequency) transmission and reception, television broadcast, television band devices, Internet data communications, short-distance wireless data communication, Wi-Fi/WiMAX networks, IEEE-802.11 wireless communication, cellular telephone data networks, CDMA networks, 3G/4G networks, high-speed communication interfaces, geo-location, handheld computing devices, central processing units (CPUs), random access memory (RAM), mechanical storage media.

TVBDs share spectrum with other authorized non-TVBD devices, such as TV stations, cable head-ends and wireless microphones. Although TVBDs are required to protect such legacy services, and must comply, as mentioned earlier, with the FCC Rules, some TVBD devices may not operate correctly, either through operator error, malfunction, or misuse. For such a reason, it is useful that a test device be available that can assure an operator of non-TVBD devices that such non-TVBD devices will operate correctly in any given situation, as well as assure an operator of a TVBD device the correct operation of their TVBD device. The instant invention provides such a function.

TVBDs operate under two general modes: fixed and portable. Fixed TVBDs must report their location regularly to an appropriate database administrator. Portable devices must either sense the local RE environment to find an unoccupied channel, or must verify unallocated channels by contacting an appropriate database administrator, either directly, or by means of an intermediate contact with either another portable TVBD (which has both a geo-location function and access to an appropriate database administrator), or a fixed TVBD device.

Accurate and synchronized TV bands databases will be used by fixed and personal portable unlicensed devices to identify unused channels in the spectrum used principally by the broadcast television service that are available at their geographic locations. The database will calculate and communicate to a TVBD which TV channels are vacant and can be used at the device's location. The database will also register the locations of fixed TVBDs and protected locations and channels of certain incumbent services that are not recorded in Commission databases. The FCC Rules state that the Commission will designate one or more entities to administer a TV bands database, and will monitor the database administration for accuracy.

In order to provide confidence that a channel used by a non-TVBD is not and will not be interfered with, it is important that the operator of the non-TVBD be assured the following when commencing operation:
1. The non-TVBD operating frequencies should be properly registered in the TVBD database;
2. Any RF radiator, including a TVBD, must be operating on a frequency that does not interfere with the operation of the registered non-TVBD.
3. Any TVBD initiating operation in the vicinity of the non-TVBD should automatically be assigned a frequency that does not interfere with the non-TVBD. If a non-interfering frequency is not found, the TVBD must not be allowed to radiate RF energy.

While the non-TVBD operator may perform these tests manually, such a group of tests would be cumbersome and perhaps expensive, especially on an ongoing basis, such as if the non-TVBDs are used sporadically. In addition, the non-TVBD operator may wish to conduct the tests on an ongoing basis, especially during mission-critical activities that could, for example, pertain to public safety, disaster, or even national security.

The invention therefore provides a simple and inexpensive way for the non-TVBD operator to achieve confidence that a channel used by a properly-registered non-TVBD is not and will not be interfered with.

### BRIEF DESCRIPTION OF THE FIGURES

FIG. 1 shows a block diagram of an apparatus constructed in accordance with this invention;

FIG. 2 shows a block diagram of an alternate embodiment;

FIG. 3 shows a block diagram of an IF module used in the embodiments;

FIG. 4 shows a block diagram of a second alternate embodiment;

FIG. 5 shows a block diagram of a third alternate embodiment;

FIG. 6 shows a flow chart for operating the apparatus;

FIG. 7 shows a flow chart including an optional RF scanning subroutine;

FIG. 8 shows a block diagram of a fourth alternate embodiment;

FIG. 9 shows a block diagram of a fifth alternate embodiment;

FIG. 10 shows a block diagram of a sixth alternate embodiment;

FIG. 11 shows a block diagram of a seventh alternate embodiment;

FIG. 12 shows a block diagram of an eighth alternate embodiment; and

FIG. 13 shows a block diagram of a ninth alternate embodiment.

### DETAILED DESCRIPTION OF THE INVENTION

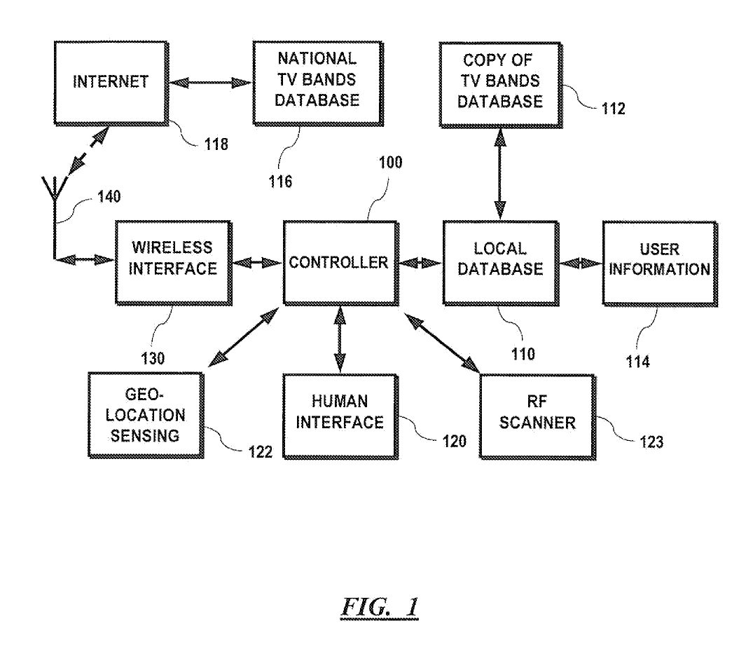

The basic building blocks of an apparatus constructed in accordance with this invention are illustrated in FIG. 1. The apparatus includes a controller (100), commonly realized by means of a central processing unit (CPU) or the like, which maintains a Local Database (110), commonly realized by means of random access memory (RAM) or other similar storage media, that contains a Copy of the National TV Bands Database (112) as well as a user-supplied User Information (114) pertaining to the user's equipment. The controller accesses the National TV Bands database (116) by means of a Wireless Interface (130) and Wireless Antenna (140) that intercommunicate with the National TV Bands Database by means of the Internet (118). The wireless interface can use any of several means for interconnection with the Internet, including the IEEE-802.11 family of standards, Wi-Fi, WiMAX, 3G and CDMA cellular, or the like. User input to the device and device information to the user is provided by means of a Human Interface (120), which can utilize any of the standard methods commonly available, such as display screens, keypads, touchpads, and the like.

If necessary, the geographic location of the device may be determined using a Geo-locating Sensor (122) (such as a GPS or other means) reporting to Controller (100). In some embodiments, the RE spectrum is scanned and the local active channels are located and reported to Controller (100) by an RE Scanner (123).

With the embodiment thus described and shown in FIG. 1, an operator of a non-TVBD can thus verify that the operating frequency (or frequencies) of their non-TVBD should be properly registered in the national TVBD database.

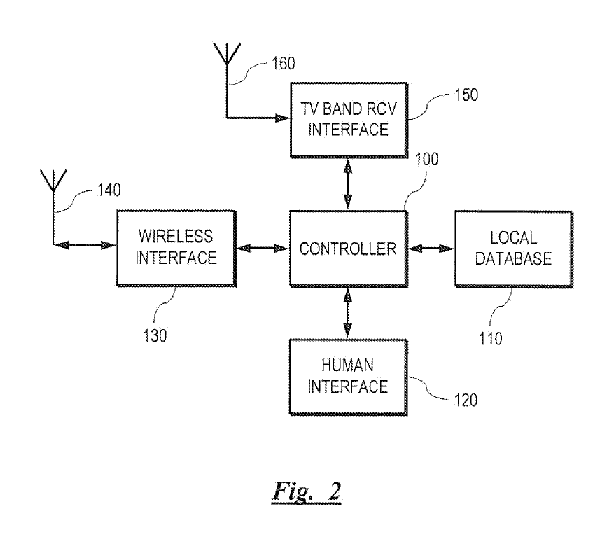

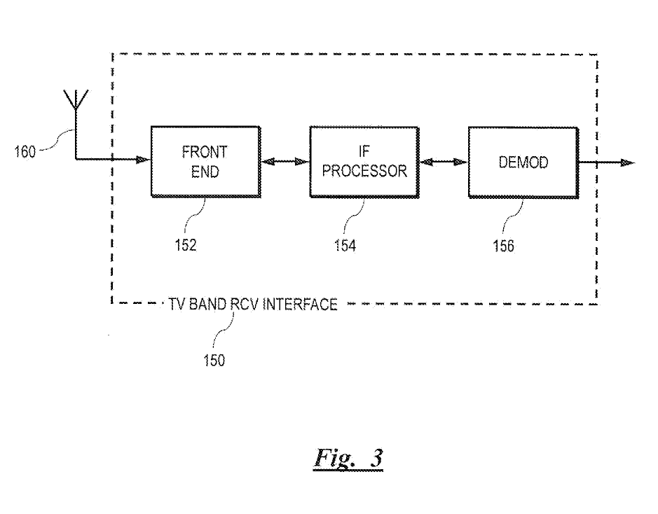

The operator of a non-TVBD can verify the actual current usage of the TV band spectrum at the site of the non-TVBD, and compare it with the information in the Local Database, by using the embodiment shown in FIG. 2. This functionality is provided by the TV Band Receiver Interface (150, shown as TV Band RCV Interface) and a suitable TV Band Receiving Antenna (160). As described before, the Wireless Interface communicates with the National TV Bands Database (116, not shown in this figure) to provide a local Copy of the TV Bands Database (112, not shown in this figure). As described before, the Local Database also contains user-supplied User Information (114, not shown in this figure). The TV Band Receiver Interface typically incorporates a “Front-end” or tuner (152), an Intermediate Frequency (IF) Processor (154), and a Demodulator (156), as shown in FIG. 3.

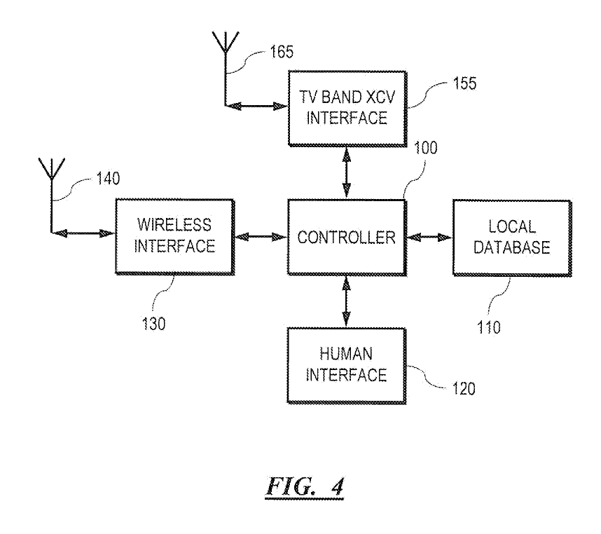

The operator of the non-TVBD can also emulate the correct operation of a TVBD by using the embodiment shown in FIG. 4. Here, a TV Band Transceiver Interface (155, shown as TV Band XCV Interface), provides a transmit-and receive function to the embodiment, allowing the device to emulate any or all of the various modes allowed by the FCC for TVBD operation, such as the Mode I or Mode II options specified in the FCC Rules, as well as the Sensing-only or Fixed modes allowed in the same FCC Rules. (Note that additional hardware, such as the Geo-locating Sensor (122) shown in FIG. 1 may be needed to fully emulate those specific modes.)

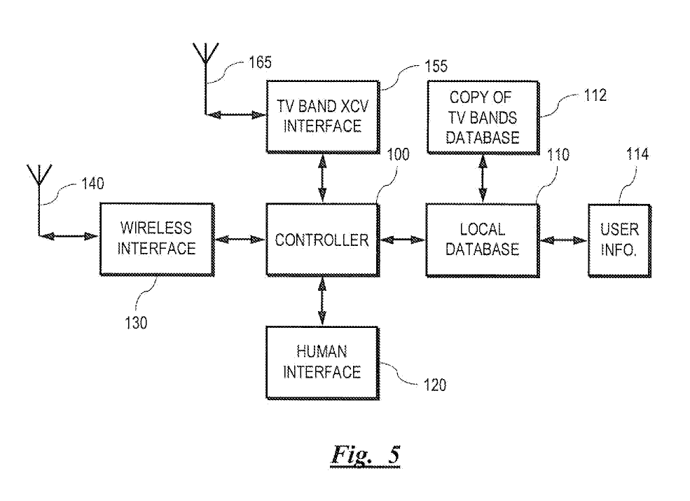

FIG. 5 shows a more detailed view of such an embodiment where, as described before, the Wireless Interface (130) communicates with the National TV Bands Database (116, not shown in this figure) to provide a local Copy of the TV Bands Database (112). As described before, the Local Database also contains user-supplied User Information (114).

Thus, an operator can use the invention shown in FIG. 5 to quickly and exhaustively test many different scenarios and, in so doing, can verify that a channel used by the operator's non-TVBD is not and will not be interfered with by other RF radiators.

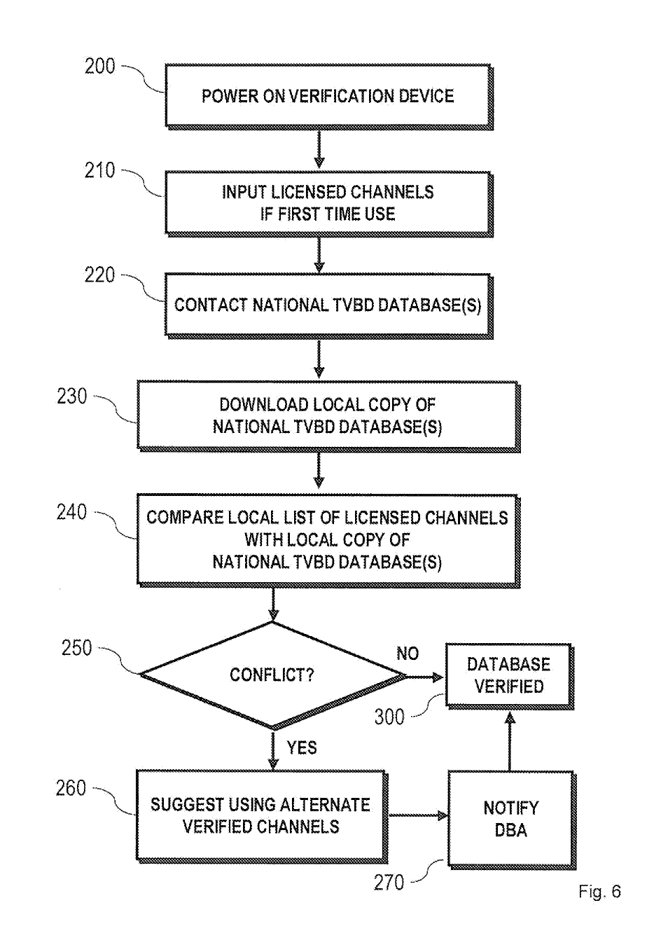

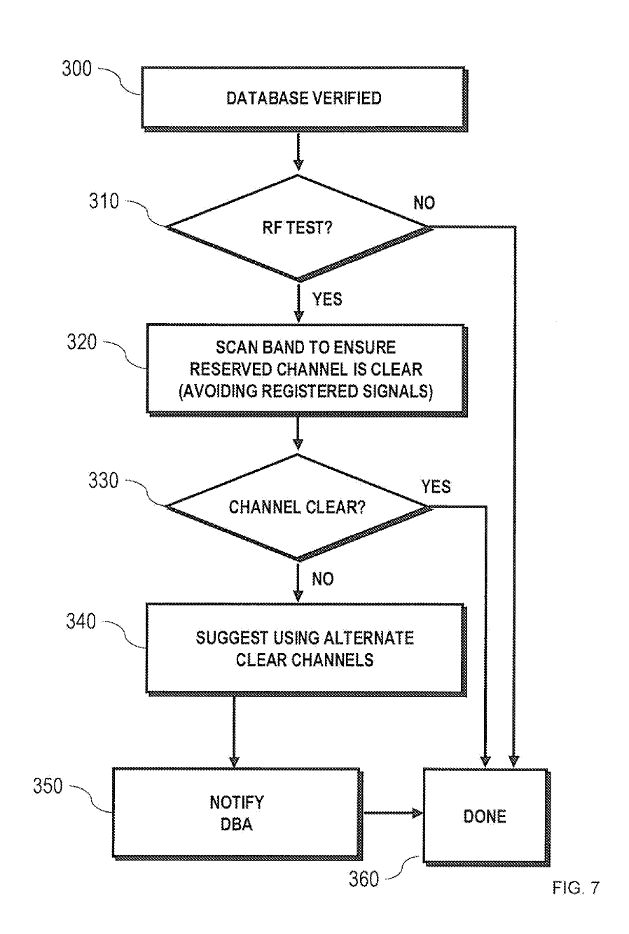

The use of the devices is demonstrated by the flow charts of FIGS. 6 and 7 illustrating a typical scenario:
1. The user powers on the Verification Device (200) which may be any of the embodiments illustrated herein.
2. The user inputs his licensed wireless channels into the Verification Device (one time only, or as an update, as necessary) (210).
3. The Verification Device contacts one or more National TV Bands Databases (220).
4. The Verification Device downloads a local copy of the National TV Bands Database (230).
5. The Verification Device compares the local list of licensed wireless channels with the local copy of the National TV Bands Database (240).
6. If a conflict is found (250), the Verification Device suggests using alternate verified channels (260).
   a. The Verification Device can contact the relevant TVBD Database Administrator for correction (270).
7. If no conflict is found, the database is verified and the User is free to use his devices interference-free (300).
8. As shown in FIG. 7, the verification device optionally performs an RF test (310) by scanning the band reserved for their wireless devices to ensure the reserved channel has been cleared (320).
   a. The scanner accounts for the licensed devices by detecting known signal characteristics (e.g., specific modulations) of the active devices registered by the user.
   b. If an unwanted signal is found in the channel, the Verification Device suggests using alternate known clear channels (340), and contacts the Database Administrator for correction (350).
   c. If no unwanted signal is found in the channel, the User is free to use his devices interference-free (360).

The Verification Device optionally can continue to monitor one or more National TV Bands Databases and/or the band reserved for their wireless devices to ensure that the devices continue to operate interference-free.

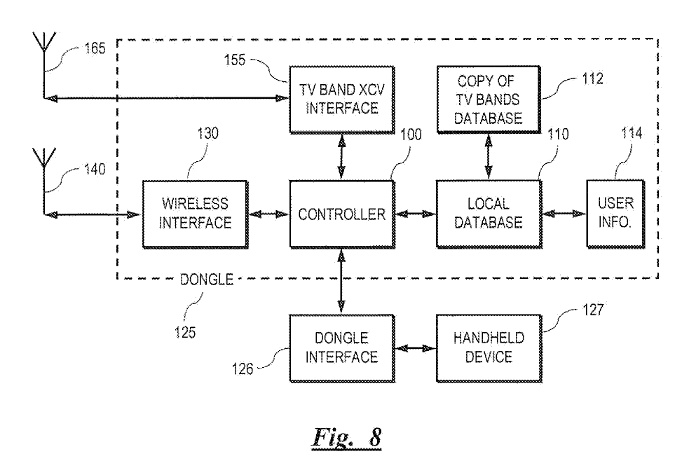

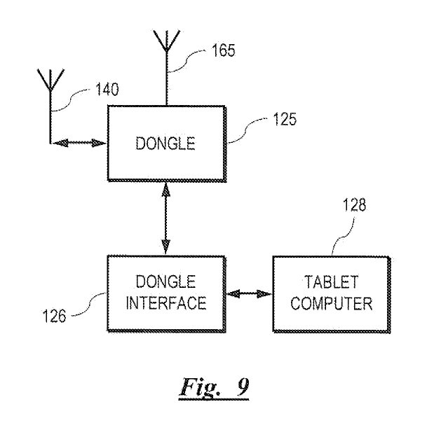

Appropriate portions of the previous embodiments, and combinations thereof, can also be integrated into a Dongle (125), as shown in FIG. 8. This Dongle could then connects through an appropriate Dongle interface (126) to any of various widely-available Handheld Devices (127), such as a Tablet Computer (128), as shown in FIG. 9 or, similarly, a smartphone (not shown here). In such an embodiment, the function of the Human Interface (120), and some or all of the various functions and algorithms required to realize the invention, are supplied by the Handheld Device including, but not limited to, those shown in the various figures.

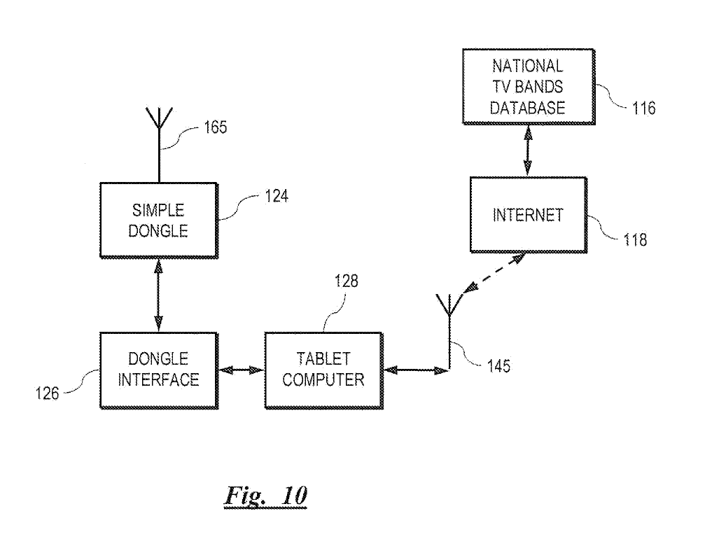

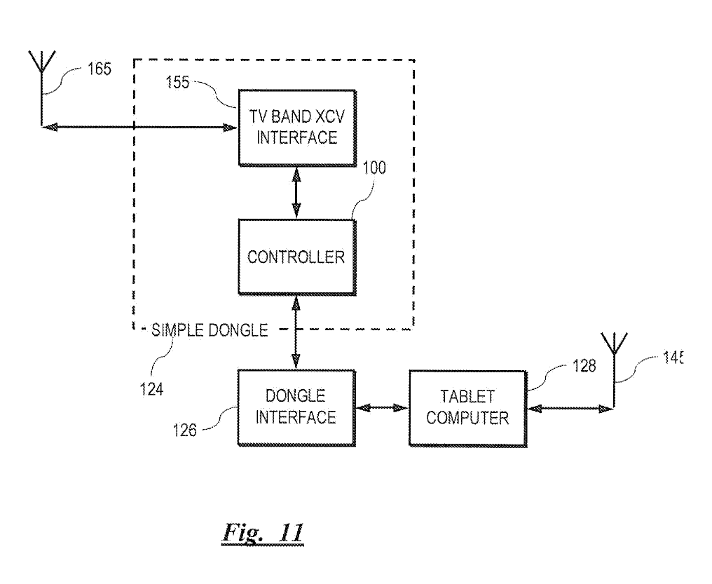

The complexity of the Dongle can be reduced by allowing the Tablet Computer (128) to intercommunicate with the National TV Bands Database (116) by means of the Tablet Computer's own WiFi Radio And Antenna (145, Radio portion not explicitly shown), as shown in FIG. 10. In this embodiment, a Simple Dongle (124) intercommunicates with the Tablet Computer as before, through a Dongle Interface (126). This embodiment of a Simple Dongle is shown in more detail in FIG. 11, with components as described before.

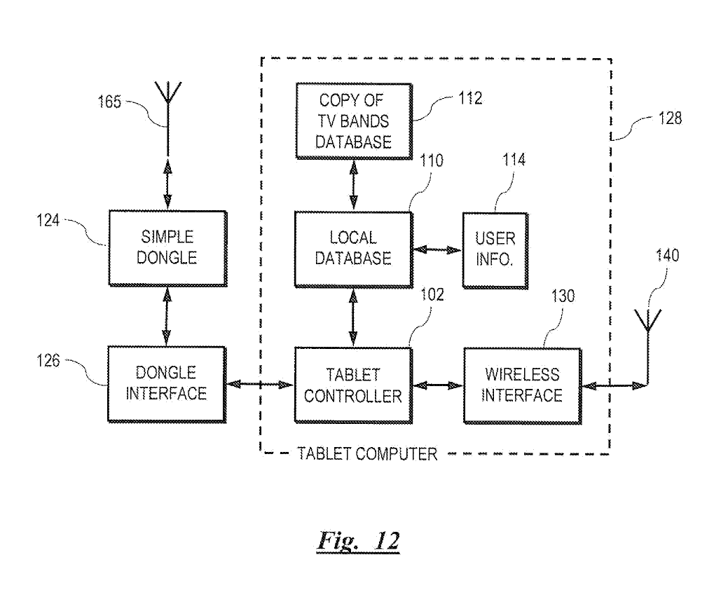

With the Simple Dongle (124), the management of the Local Database (110) is now taken up by the Tablet Computer (128) by means of the Tablet Controller (102) therein, as shown in FIG. 12. In this same figure, the Wireless Interface (130) and Wireless Antenna (140) are now shown separately.

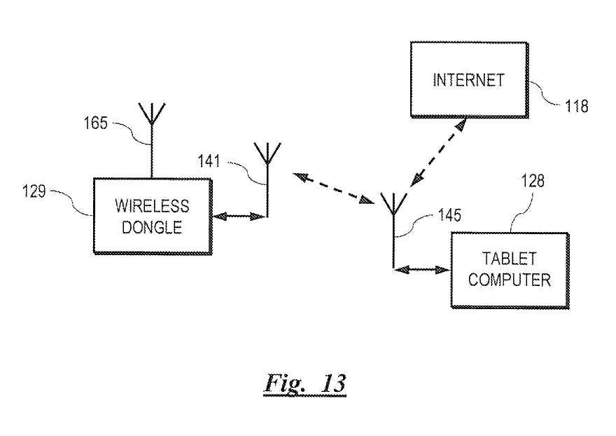

In a different embodiment, a Wireless Dongle (129), shown in FIG. 13, can obviate the need for a wired communications connection between the Controller (100) (shown earlier) and the Tablet Computer (128) or similar Handheld Device, by using a Wireless Interface And Wireless Antenna (141) to intercommunicate with the Tablet Computer by means of the WiFi Radio And Antenna (145) on the Tablet Computer. (In this respect, the Wireless Dongle is very similar to the Dongle shown previously in FIG. 8, the difference being the absence of a hardwire connection between the Controller (100) and the Handheld Device (127) in that figure.) Again, as was illustrated in FIG. 12, the Local Database (110) is now maintained by the Tablet Computer (128) and stored therein. In this same embodiment of a Wireless Dongle, the software and algorithms running in the Tablet Computer would manage separate wireless connections to the Wireless Dangle and to the Internet (118), and switch between these wireless connections as required. Although this could necessitate breaking and re-establishing the alternate wireless connections, the required switching can take place at a relatively slow rate, since the interconnection with the National TV Bands Database would not need to be constantly updated.

Other variations:
1. The various embodiments or portions thereof described heretofore can alternatively be realized by means of software or a software “app” running on any of various existing computing devices, when the necessary interfaces are provided or available.
2. The Wireless Antenna (140) and TV Band Receiving Antenna (160) shown in the various figures can be realized by a single appropriately-integrated antenna and interface network providing appropriate transmit/receive isolation.
3. The Wireless Antenna (140) and TV Band Transmit/Receive Antenna (165) shown in the various figures can be realized by a single appropriately-integrated antenna and interface network providing appropriate transmit/receive isolation.
4. In the embodiments described herein, the TV Band Receiver Interface (150) can be replaced with the TV Band Transceiver Interface (155) or vice versa, with appropriate changes to the respective antennas. This, of course, changes the range of operating conditions for the particular embodiment.
5. The TV Band Receiver Interface (150) could also be realized by omitting the Demodulator (156), since the IF Processor (154) could perform the necessary function of usage analysis of the TV band spectrum.
6. The TV Band Receiver Interface (150) could be realized by portions of an existing tuner used for receiving and reproducing broadcast digital video, audio and other content. In this fashion, the hardware needed to realize the invention could serve the dual purpose of providing assured communications in the operation of wireless devices as well as receiving and reproducing digital video, audio and other content.
7. The Wireless Interface shown in the various figures can be replaced with a wired connection, such as IEEE 802.3 (Ethernet).
8. The Wireless Interface and Wireless Antenna shown in the various figures can be replaced by any other suitable connection to the Internet, including wired and other means.
9. The operator of a non-TVBD can determine the actual current usage of the TV band spectrum at the site of the non-TVBD, without comparing it with the information in the Local Database. In this fashion, the invention can function in a manner similar to that of a spectrum analyzer.
10. The spectrum analyzer function can be used without accessing the National TV Bands Database.
11. The spectrum analyzer function can be embodied without the presence of a Wireless Interface or Wireless Antenna.
12. The spectrum analyzer function can be embodied without any connection to the Internet.
13. With either the Single Dongle or the Wireless Dongle, the role of the Tablet Computer could similarly be fulfilled with other Handheld Devices.
14. The Handheld Device could alternatively take the form of a fixed computer.

While the descriptions and variations heretofore have referred to the use of this invention by an operator of a non-TVBD, the functionalities described herein can be utilized by any other interested party as well, including users of TVBDs and other potential devices, including but not limited to RF modulators, transmitters, TV receivers, and so forth.

We claim:

1. An apparatus for verifying the availability of RF channels for non TVBD devices comprising:
a controller;
a memory connected the controller with a local list of licensed RF channels designated for the location of the apparatus; and
a receiver receiving a remote list from a national database;
wherein said controller is adapted to compare said local list to said remote list and generate an output to confirm that the local list is consistent with the remote list.

2. The apparatus of claim 1 further comprising a geolocation sensor to sense the location of the apparatus.

3. The apparatus of claim 1 further comprising a user interface.

4. The apparatus of claim 3 wherein said local list is received from said user interface.

5. The apparatus of claim 1 further comprising an RF scanner scanning the local RF spectrum to generate or augment said local list.

6. The apparatus of claim 1 wherein said controller is adapted to send a message to a remote national database indicating the results of said comparison.

7. The apparatus of claim 1 wherein said controller is adapted to send a correction message to update said national database if said comparison indicates a discrepancy between said local and said remote lists.

8. A method of verifying the availability of local RF channels using a programmable verification apparatus comprising the steps of:
establishing a local list of active RF channels in said apparatus;
downloading a remote list of active RF channels from a remote national database to said apparatus;
comparing by said apparatus said local and said remote lists; and
generating an report to a user based on said comparison.

9. The method of claim 8 further comprising introducing said local list by a user through a user interface.

10. The method of claim 8 further comprising determining the location of said programmable verification apparatus by using a geolocation sensor.

11. The method of claim 8 further comprising scanning the local RF spectrum to determine said local list.

12. The method of claim 8 further comprising generating a message and sending said message to the remote national database with corrections.

13. An apparatus for verifying the active TV band channels for non TVBD devices at a locality comprising:
a controller;
a memory with a local database identifying an active local TV band channel; and
a TV band transceiver;
wherein the controller monitors signals from said TV band transceiver to determine the active local TV band channels and stores the identification of said channels into said memory.

14. The apparatus of claim 13 wherein said controller is adapted to receive information from a remote database and compare said information to said local database to determine which channels are available for non TVBD devices.

15. The apparatus of claim 13 further comprising a housing shaped and sized to couple to a hand-held user device, said controller, memory and receiver being disposed in said housing.

16. The apparatus of claim 15 wherein said housing is adapted to be coupled to a smart phone.

17. The apparatus of claim 15 wherein said housing is adapted to be coupled to a tablet computing device.

18. The apparatus of claim 15 wherein said controller is adapted to transmit and receive information from the remote database through the hand-held device.
